(19) United States
(12) Patent Application Publication
(10) Pub. No.: US 2024/0338594 A1
(43) Pub. Date: Oct. 10, 2024

(54) PERFORMING AUTOMATED TICKET CLASSIFICATION

(71) Applicant: Oracle International Corporation, Redwood Shores, CA (US)

(72) Inventors: Chunming Liu, Bellevue, WA (US); Kexin (Cathy) Cui, Bellevue, WA (US); Chengfei Li, Irvine, CA (US); Kai (Jason) Yin, Sammamish, WA (US)

(73) Assignee: Oracle International Corporation, Redwood Shores, CA (US)

(21) Appl. No.: 18/132,914

(22) Filed: Apr. 10, 2023

(51) Int. Cl. G06N 20/00

(52) U.S. Cl. CPC G06N 20/00

(57) ABSTRACT

According to certain implementations, tickets generated in response to system incidents may be automatically labeled utilizing a trained machine learning model, where such labels indicate (1) whether the ticket needs user attention and/or (2) a severity of the incident that prompted the ticket. Only tickets labeled as needing attention may be provided to users (such as systems engineers) for additional analysis, and tickets labeled as not needing user attention may be discarded and/or stored without being delivered to a user for additional analysis. Tickets may also be sorted according to a severity of the incident associated with the ticket, which may ensure that incidents with a higher severity level are prioritized over incidents with a lower severity level.

### BACKGROUND

In a cloud computing environment, due to the complexity and breadth of the environment, detecting problems in the environment is a big and complicated task. In some cloud environments, alarms may be configured that get triggered when certain incidents occur within such environments. An incident could be failure of a software or hardware component in the environment, a reduction in the capability or functionality of a software or hardware component in the environment, a loss of a service offered by the computing environment, and the like. Tickets may be issued in response to one or more alarms, where a ticket identifies a potential problem in the cloud computing environment. In a large cloud computing environment, a large number of tickets may be issued.

Once these tickets are issued, they are assigned to one or more users (e.g., service engineers) who are tasked with investigating the causes of their assigned tickets and taking remedial actions. Due to the large number of tickets that are typically generated in a large-scale cloud computing environment, cloud service providers have to allocate a large number of human resources to investigating these tickets and taking remedial actions where needed. As a result, a substantial amount of time is spent on ticket investigation and remediation.

However, statistically, it is seen that not all tickets are of equal impact or importance for the cloud computing environment. In fact, only a small fraction of the issued tickets may need to be investigated, and a large portion of issued tickets may be ignored. However, this decision of whether a ticket needs to be investigated or not is currently done manually, requiring a substantial investment of time and computing resources.

### BRIEF SUMMARY

The present disclosure relates generally to ticket classification. More particularly, novel techniques are described for performing automated ticket classification utilizing a trained machine learning model. Various embodiments are described herein to illustrate various features. These embodiments include various methods, systems, non-transitory computer-readable storage media storing programs, code, or instructions executable by one or more processors, and the like.

According to certain implementations, tickets generated in response to system incidents may be automatically labeled utilizing a trained machine learning model, where such labels indicate (1) whether the ticket needs user attention and/or (2) a severity of the incident that prompted the ticket. Only tickets labeled as needing attention may be provided to users (such as systems engineers) for additional analysis, and tickets labeled as not needing user attention may be discarded and/or stored without being delivered to a user for additional analysis. Tickets may also be sorted according to a severity of the incident associated with the ticket, which may ensure that incidents with a higher severity level are prioritized over incidents with a lower severity level.

At least one embodiment is directed to a computer-implemented method. The method can include identifying, by a computer system, an unlabeled ticket generated in response to an occurrence of a current incident; determining, by the computer system, a time window starting at a predetermined time before the occurrence of the current incident and ending at a time after the occurrence of the current incident; retrieving, by the computer system, system performance data determined during the time window; determining and labeling, by the computer system, anomalies within the system performance data to create labeled system performance data; determining, by the computer system, system health data during the time of the current incident; and determining, by the computer system utilizing a trained machine learning model, a label for the unlabeled ticket, utilizing the unlabeled ticket, the labeled system performance data, and the system health data.

Another embodiment is directed to a system comprising one or more processors and instructions that, when executed by the one or more processors, cause the computing device to perform any suitable combination of the method(s) disclosed herein.

Still another embodiment is directed to a non-transitory computer-readable medium storing computer-executable instructions that, when executed by one or more processors of a computing cluster, cause the computing cluster to perform any suitable combination of the method(s) disclosed herein.

The foregoing, together with other features and embodiments will become more apparent upon referring to the following specification, claims, and accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an exemplary ticket categorization environment, according to at least one embodiment.

FIG. 2 is a block diagram of an exemplary ticket categorization model training environment, according to at least one embodiment.

FIG. 3 illustrates an example method for performing automated ticket classification, according to at least one embodiment.

FIG. 4 illustrates an example method for training a machine learning model to perform automated ticket classification, according to at least one embodiment.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

A solution is provided that uses automated machine learning (ML) based techniques for categorizing tickets. In certain embodiments, the ML model is trained to predict a category (e.g., a label) for each ticket, where the ticket is categorized as either requiring attention or that it can be ignored. In some other embodiments, the category predicted for a ticket can be selected from a set of categories including different levels (e.g., high, medium, low) of impact/importance/priority for the ticket.

The processing includes (1) a training phase in which the ML model is trained using historical data to make predictions for tickets; and (2) an inference phase during which a trained ML model is used to make predictions on tickets generated in a cloud computing environment.

### Training Phase

In the training phase, historical tickets are identified that were each generated in response to an occurrence of an historical incident within a cloud computing environment. These historical tickets already have a category/label assigned to them (e.g., manually assigned by a user). Based on information (such as metadata) within the historical tickets, a time at which the historical incident occurred is determined. A time window is calculated that starts at a predetermined time before the occurrence of the historical incident and stops when the historical ticket is delivered to a destination (such as a service engineer). Based on information within the historical ticket, one or more components are determined within the cloud computing environment that were impacted by the historical incident. Performance metrics (such as time series, key performance indicator (KPI) metrics, etc.) determined for those components during the time window are then retrieved. These performance metrics may be retrieved from a repository such as a runbook.

These retrieved performance metrics are then analyzed to determine any anomalies within the metrics. Any anomalies are labeled within the performance metrics to create labeled performance metrics. General health data determined for the cloud computing environment during the time of each historical incident is also retrieved. This general health data may be retrieved for a predetermined time period before and after the occurrence of each historical incident.

An ML model is then trained to determine the historical labels assigned to the historical tickets. Training data includes the historical tickets, the historical labels, the labeled performance metrics for each historical ticket, and the general health data associated with each historical ticket. This training may be performed using many historical tickets and their associated information (e.g., the historical label for the historical ticket, the labeled performance metrics for the historical ticket, and the general health data for this historical ticket). For example, the ML model may be trained to output a corresponding historical label when provided with an historical ticket, the labeled performance metrics, and the general health data as input. For each historical ticket, a region identifier indicating a region within the system where the historical incident occurred may also be included as input during training. The ML model may be validated after training.

The label may include a binary label value—for example, a value of one may indicate that the second ticket represents an incident that needs user attention, and a value of zero may indicate that the second ticket represents an incident that does not need user attention. The label may also include an integer value indicating a severity of the second incident for which the second ticket was generated.

### Inference Phase

In the inference phase, a current ticket is identified that was generated in response to an occurrence of a current incident within a cloud computing environment. This current ticket does not have a category/label assigned to it. Based on information (such as metadata) within the current ticket, a time at which the current incident occurred is determined. A time window is calculated that starts at a predetermined time before the occurrence of the time window and stops when the current ticket is input into a trained ML model (e.g., when inference is performed). For example, inference may be performed immediately before the current ticket is delivered to the destination (such as a service engineer).

Based on information within the current ticket, one or more components are determined within the cloud computing environment that were impacted by the current incident. Performance metrics (such as time series, key performance indicator (KPI) metrics, etc.) determined for those components during the time window are then retrieved (e.g., from a repository such as a runbook).

These retrieved performance metrics are then analyzed to determine any anomalies within the metrics. Any anomalies are labeled within the performance metrics to create labeled performance metrics. General health data determined for the cloud computing environment during the time of the current incident is also retrieved. This general health data may be retrieved for a predetermined time period before and after the occurrence of the current incident.

The current ticket, the labeled performance metrics, and the general health data may then be provided as input into the trained ML model (see above for training details). A region identifier indicating a region within the system where the current incident occurred may also be included as input to the ML model. The ML model may perform inference on the input and may output a category/label for the current ticket.

In this way, tickets generated in response to system incidents may be automatically labeled, where such labels indicate whether the ticket needs user attention and/or a severity of the incident that prompted the ticket. Only tickets labeled as needing attention may be provided to users (such as systems engineers) for additional analysis, and tickets labeled as not needing user attention may be discarded and/or stored without being delivered to a user for additional analysis. Tickets may also be sorted according to a severity of the incident associated with the ticket, which may ensure that incidents with a higher severity level are prioritized over incidents with a lower severity level. This may reduce an amount of tickets that are processed, which may reduce an amount of computing resources necessary for such processing, thereby improving a performance of such computing resources.

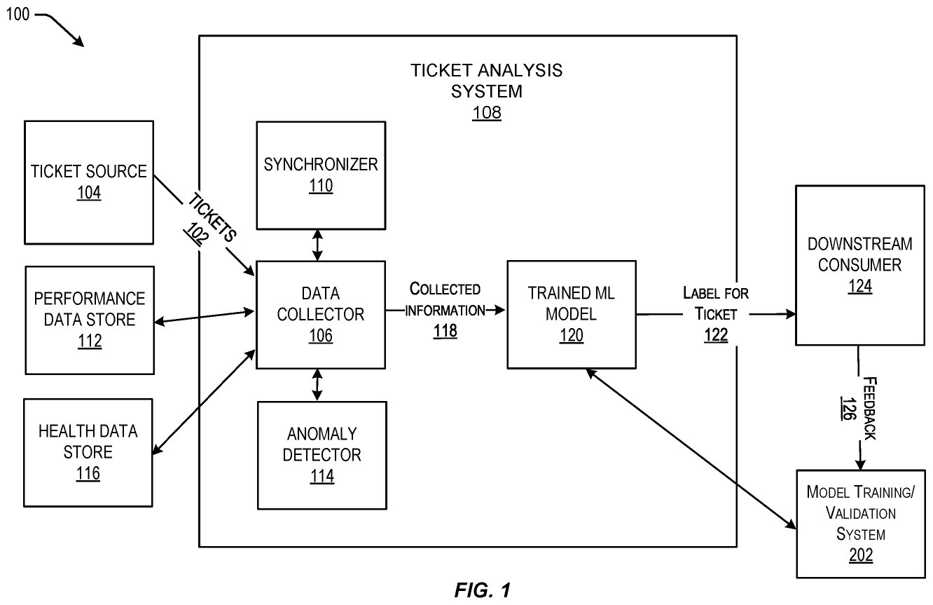

FIG. 1 illustrates an exemplary ticket categorization environment 100, according to one exemplary embodiment. As shown, unlabeled tickets 102 are generated by a ticket source 104 and sent from the ticket source 104 to a data collector 106 of a ticket analysis system 108. In various embodiments, the ticket source 104 may include a computing device (such as a server) that monitors a system (such as a cloud computing environment, a multi-tenant environment, etc.) and creates the unlabeled tickets 102 in response to detecting one or more incidents within the system.

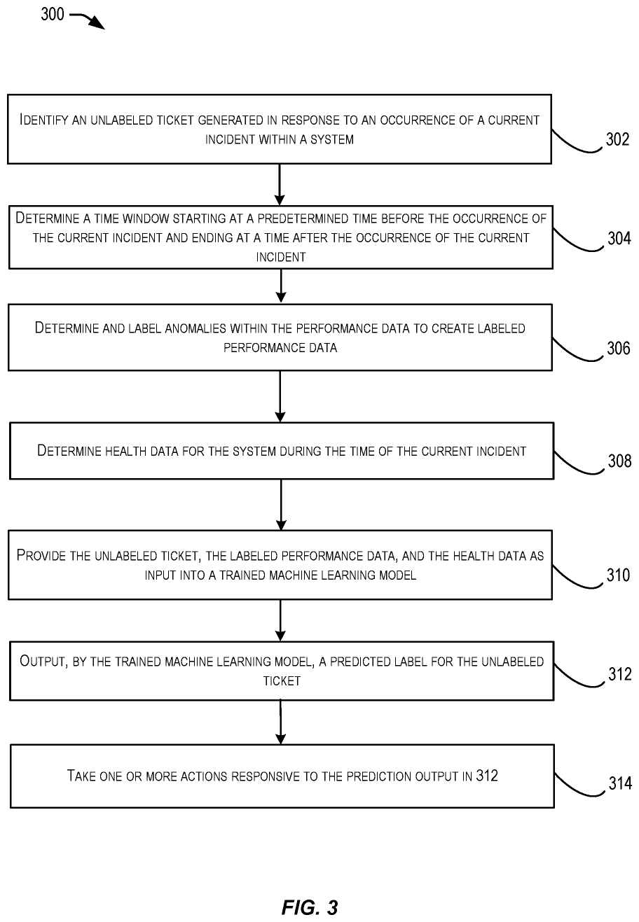

For example, the ticket source 104 may identify incidents such as a dropped session within the system, a lost connection within the system, lost data within the system, component failure within the system, etc. The ticket source may then generate unlabeled tickets 102 in response to the identified incidents. The unlabeled tickets 102 may be noted as “unlabeled” in that each of the unlabeled tickets 102 does not include a label indicating a severity of the incident associated with the ticket and/or an indication as to whether the incident associated with the ticket requires user attention. Each of the unlabeled tickets 102 may include characteristics such as metadata. Additional detail regarding characteristics of the unlabeled tickets 102 is illustrated in step 302 of FIG. 3.

Additionally, the data collector 106 may include hardware and/or software implemented within the ticket analysis system 108. The ticket analysis system 108 may include a computing device such as a server, one or more nodes of a distributed computing system, etc.

Further, for each of the unlabeled tickets 102 received from the ticket source 104, the data collector 106 may communicate with a synchronizer 110, and the synchronizer 110 may determine a time window for the incident associated with the unlabeled ticket, starting at a predetermined time before the occurrence of the incident and ending at a time after the occurrence of the incident. The synchronizer 110 may include hardware and/or software implemented within the ticket analysis system 108. Additional detail regarding the determination of the time window is illustrated in step 304 of FIG. 3. After determining the time window for the incident associated with the unlabeled ticket, the synchronizer 110 may return such time window to the data collector 106.

Further still, for each of the unlabeled tickets 102 received from the ticket source 104, the data collector 106 may then retrieve from a performance data store 112 performance data determined for the system (e.g., the system being monitored by the ticket source 104) during the determined time window for the incident associated with the unlabeled ticket. The performance data store 112 may include a runbook, and the performance data may include key performance indicator (KPI) metrics. Additional detail regarding the retrieval of performance data is illustrated in step 306 of FIG. 3.

Also, for each of the unlabeled tickets 102 received from the ticket source 104, the data collector 106 may then send the associated performance data to an anomaly detector 114, which may determine and label anomalies within the performance data to create labeled performance data. The anomaly detector 114 may include hardware and/or software implemented within the ticket analysis system 108. In various embodiments, for each of the unlabeled tickets 102, the anomaly detector 114 may review each instance of the associated performance data for the ticket (e.g., utilizing a sliding window algorithm, etc.) and may label each instance of the associated performance data as anomalous or non-anomalous. Additional detail regarding the determination and labeling of anomalies within performance data is illustrated in step 308 of FIG. 3.

In addition, for each of the unlabeled tickets 102 received from the ticket source 104, the data collector 106 may also determine, from a health data store 116, health data for the system (e.g., the system being monitored by the ticket source 104) during the time of the incident associated with the ticket. The health data store 116 may include one or more data storage devices, one or more databases, etc. Additional detail regarding the determination of health data for the system is illustrated in step 310 of FIG. 3.

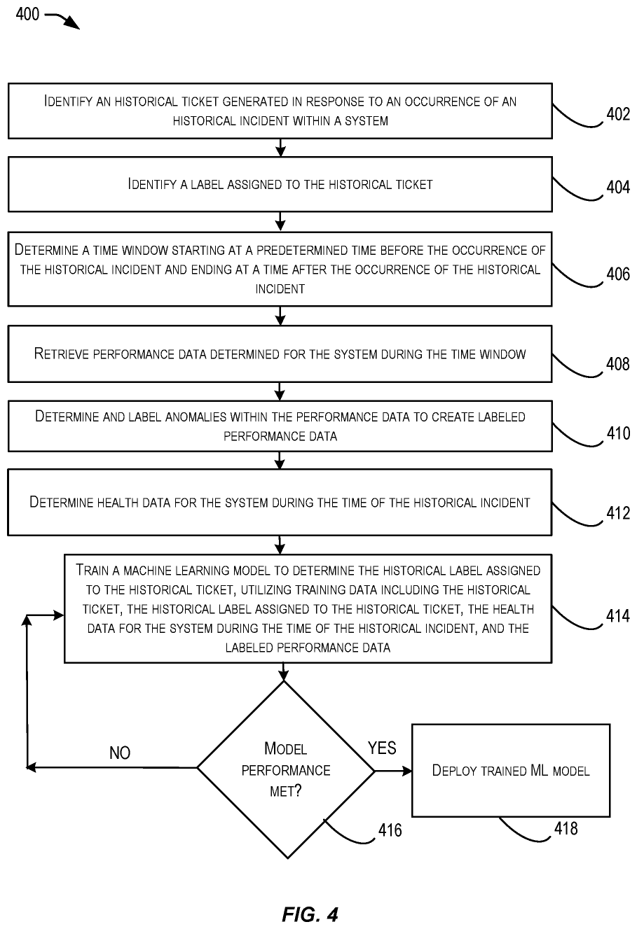

Furthermore, for each of the unlabeled tickets 102 received from the ticket source 104, the data collector 106 may then provide collected information 118 as input to a trained machine learning (ML) model 120. The collected information 118 may include the unlabeled ticket 102, as well as the labeled performance data and the health data determined for the unlabeled ticket 102. Additional detail regarding the training of the ML model 120 is illustrated in FIG. 4.

Further still, the trained ML model 120 may perform inference on the collected information 118, and may provide as output a label 122 for the unlabeled ticket 102. Additional detail regarding the determination of the label 122 by the trained ML model 120 is illustrated in step 312 of FIG. 3. The label 122 provided by the trained ML model 120 may then be provided to a downstream consumer 124, such as one or more users, one or more applications, etc.

For example, the downstream consumer 124 may deliver a ticket to a user tasked with analyzing and/or resolving the incident in response to identifying a predetermined label 122 for the ticket (such as a value of one indicating that the ticket represents an incident that needs user attention). In another example, the downstream consumer 124 may discard a ticket in response to identifying a predetermined label 122 for the ticket (such as a value of zero indicating that the ticket represents an incident that does not need user attention). In another example, the downstream consumer 124 may arrange a group of tickets according to their associated labels 122, and may prioritize certain tickets according to the arrangement.

Also, the downstream consumer 124 may provide feedback 126 to a model training/validation system 202. This feedback 126 may include an indication as to whether the label 122 determined by the trained ML model 120 is accurate or inaccurate. In response to receiving the feedback 126, the model training/validation system 202 may made adjustments to the trained ML model 120 to increase the accuracy of the trained ML model 120.

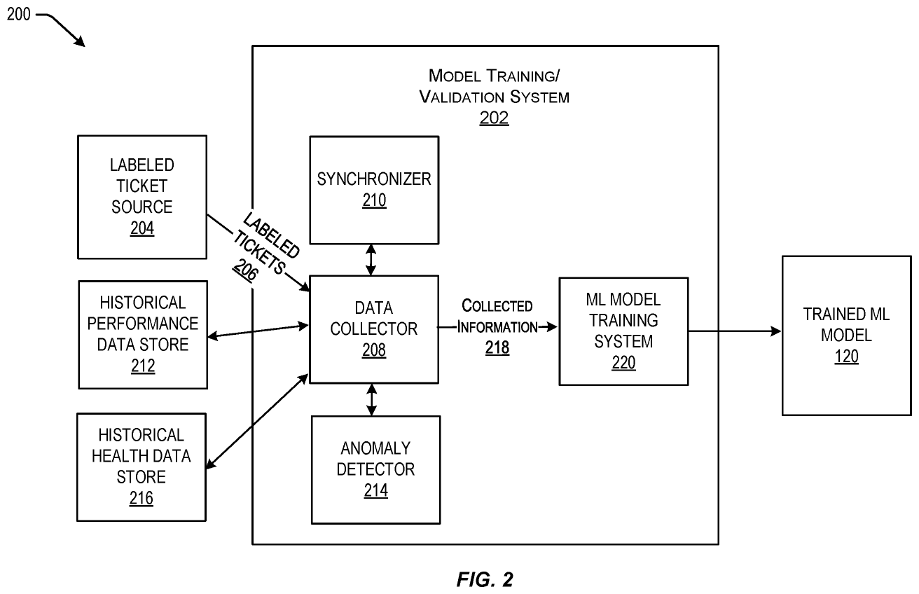

FIG. 2 illustrates an exemplary ticket categorization model training environment 200, according to one exemplary embodiment. As shown, historical labeled tickets 206 are sent from a labeled ticket source 204 to a data collector 208 of a model training/validation system 202. In various embodiments, the labeled ticket source 204 may include a database that stores historical tickets that have been previously labeled (either manually or automatically via one or more implementations, including utilizing a trained ML environment such as the trained ML model 120 of FIG. 1). Each of the historical labeled tickets 206 may include characteristics such as metadata. Each of the historical labeled tickets 206 may be created in response to an identified historical incident. Additional detail regarding characteristics of the historical labeled tickets 206 is illustrated in step 402 of FIG. 4.

Additionally, the data collector 208 may include hardware and/or software implemented within the model training/validation system 202. In various embodiments, the data collector 208 of FIG. 2 may be the same as (or different from) the data collector 106 of FIG. 1. The model training/validation system 202 may include a computing device such as a server, one or more nodes of a distributed computing system, etc.

Further, for each of the historical labeled tickets 206 received from the labeled ticket source 204, the data collector 208 may communicate with a synchronizer 210, and the synchronizer 210 may determine a time window for the historical incident associated with the labeled ticket, starting at a predetermined time before the occurrence of the historical incident and ending at a time after the occurrence of the historical incident. The synchronizer 210 may include hardware and/or software implemented within the model training/validation system 202. The synchronizer 210 may be the same as (or different from) the synchronizer 110 of FIG. 1. Additional detail regarding the determination of the time window is illustrated in step 406 of FIG. 4. After determining the time window for the historical incident associated with the historical labeled ticket, the synchronizer 210 may return such time window to the data collector 208.

Further still, for each of the historical labeled tickets 206 received from the labeled ticket source 204, the data collector 208 may then retrieve from an historical performance data store 212 historical performance data determined for the system (e.g., the system being monitored) during the determined historical time window for the historical incident associated with the historical labeled ticket 206. The historical performance data store 212 may include a runbook, and the performance data may include key performance indicator (KPI) metrics. Additional detail regarding the retrieval of performance data is illustrated in step 408 of FIG. 4. The historical performance data store 212 may be the same as (or different from) the performance data store 112 of FIG. 1.

Also, for each of the historical labeled tickets 206 received from the labeled ticket source 204, the data collector 208 may then send the associated performance data to an anomaly detector 214, which may determine and label anomalies within the performance data to create labeled performance data. The anomaly detector 214 may include hardware and/or software implemented within the model training/validation system 202. The anomaly detector 214 may be the same as (or different from) the anomaly detector 114 of FIG. 1. In various embodiments, for each of the historical labeled tickets 206, the anomaly detector 214 may review each instance of the associated performance data for the ticket (e.g., utilizing a sliding window algorithm, etc.) and may label each instance of the associated performance data as anomalous or non-anomalous. Additional detail regarding the determination and labeling of anomalies within performance data is illustrated in step 410 of FIG. 4.

In addition, for each of the historical labeled tickets 206 received from the labeled ticket source 204, the data collector 208 may also determine, from an historical health data store 216, historical health data for the system (e.g., the system being monitored) during the time of the historical incident associated with the labeled historical ticket. The historical health data store 216 may include one or more data storage devices, one or more databases, etc. The historical health data store 216 may be the same as (or different from) the health data store 116 of FIG. 1. Additional detail regarding the determination of health data for the system is illustrated in step 412 of FIG. 4.

Furthermore, for each of the historical labeled tickets 206 received from the labeled ticket source 204, the data collector 208 may then provide collected information 218 as input to a machine learning (ML) model training system 220. The collected information 218 may include the historical labeled ticket 206, the historical label assigned to the historical labeled ticket 206, the labeled performance data, and the health data determined for the historical labeled ticket 206. The ML model training system 220 may then train an ML model 120, utilizing the collected information 218. Additional detail regarding the training of the ML model 120 is illustrated in step 414 of FIG. 4.

After training is completed, the trained ML model 120 may be deployed for use (e.g., within the ticket analysis system 108 of FIG. 1, etc.).

FIG. 3 illustrates an example method 300 for performing automated ticket classification, according to at least one embodiment. The method 300 may be performed by one or more components of FIGS. 1-2 and 5-9. A computer-readable storage medium comprising computer-readable instructions that, upon execution by one or more processors of a computing device, cause the computing device to perform the method 300. The method 300 may performed in any suitable order. It should be appreciated that the method 300 may include a greater number or a lesser number of steps than that depicted in FIG. 3.

The method 300 may begin at 302, where an unlabeled ticket generated in response to an occurrence of a current incident within a system is identified. In various embodiments, the system may include a cloud computing environment, a multi-tenant environment, etc. In various embodiments, the incident may include one or more errors within the system (e.g., a dropped session within the system, a lost connection within the system, lost data within the system, component failure within the system, etc.).

Additionally, in various embodiments, the incident may include an alarm triggered by the system in response to one or more criteria (e.g., a dropped connection within the system, lost data within the system, etc.). In various embodiments, the ticket may include metadata including one or more of a description of the incident, timestamp data indicating a date and time of the incident, location data indication a location of the incident within the system, one or more components and/or users of the system affected by the incident, etc. In various embodiments, the ticket may be automatically generated by the system (or by a computing entity such as a server that monitors the system but is separate from the system), manually generated by one or more users of the system, etc.

Further, in various embodiments, the incident may be associated with a predetermined component of the system. For example, the incident may occur within a predetermined entity within the system, a predetermined service provided by the system, hardware implemented within the system, etc. In another example, the incident may occur within a compute component of the system, within a storage component of the system, within a network component provided by the system, etc. In various embodiments, the ticket may include a request (e.g., a request to one or more users) to review the incident within the system.

Further still, at 304, a time window is determined, the time window starting at a predetermined time before the occurrence of the current incident and ending at a time after the occurrence of the current incident. In various embodiments, the time window may include both a pre-incident portion and post-incident portion. In various embodiments, the pre-incident portion of the time window may encompass a predetermined time duration (e.g., ten minutes, one hour, one day, etc.).

Also, in various embodiments, a synchronizer system may identify a first time (T1) at which the current incident occurred within the system (or, alternately, a time at which the current ticket was generated). For example, the synchronizer system may identify the time T1 by parsing one or more event logs, parsing timestamp data stored as metadata within the ticket, etc. In various embodiments, the synchronizer system may determine the predetermined time duration D. In various embodiments, the pre-incident portion of the time window may be determined (e.g., by the synchronizer system) to start at time (T1-D) and to end at time T1.

In addition, in various embodiments, the post-incident portion of the time window may encompass the entire time period occurring between the occurrence of the current incident within the system and a delivery of the ticket to the destination. For example, a synchronizer system may identify a first time (T1) at which the current incident occurred within the system. The synchronizer system may identify the time T1 by parsing one or more event logs, parsing timestamp data stored as metadata within the historical ticket, etc. In another example, The synchronizer may identify a second time (T2) at which the ticket was delivered to the destination. The destination may include a user, the user including an engineer tasked with analyzing and/or resolving the incident. A timestamp may be recorded when the historical ticket is delivered to the destination, and this timestamp may be retrieved by the synchronizer system.

Furthermore, in various embodiments, the post-incident portion of the time window may encompass the entire time period occurring between the occurrence of the current incident within the system and a removal of the ticket from an analysis queue. For example, a synchronizer system may identify a first time (T1) at which the current incident occurred within the system. The synchronizer system may identify the time T1 by parsing one or more event logs, parsing timestamp data stored as metadata within the historical ticket, etc.

Further still, in various embodiments, the synchronizer may identify a second time (T2) at which the ticket was removed from a queue (such as an analysis queue). In response to the occurrence of the current incident within the system, the ticket may be generated for the event. This ticket may be added to a queue (such as an analysis queue). The ticket may be removed from the queue for delivery to a destination. A timestamp may be recorded when the historical ticket is removed from the queue, and this timestamp may be retrieved by the synchronizer system.

Also, in various embodiments, the post-incident portion of the time window may be determined (e.g., by the synchronizer system) to start at time T1 and to end at time T2. In various embodiments, a length of the post-incident portion of the time window may include a default/predetermined time value. In various embodiments, a length of the post-incident portion of the time window may be calculated based on an historical status of the analysis queue. The length of the post-incident portion of the time window may be determined based on an average backlog ticket time for historical tickets at the time the current ticket was generated.

Additionally, in various embodiments, the average backlog ticket time may include an average time taken to address each of the tickets in the analysis queue at the time the current ticket is generated. In various embodiments, a length of the post-incident portion of the time window may be calculated based on historical training data. For example, a post-incident portion of time windows for historical incidents used to train the machine learning model may be determined. These historical incidents may be selected based on one or more criteria that match the current incident, such as a matching type of incident, incidents that affect one or more predetermined components that are also affected by the current incident, etc. In another example, a time duration of these post-incident portions may be averaged to determine a time duration for the post-incident portion of the time window for the current incident.

Further, at 306, performance data determined for the system during the time window is retrieved. In various embodiments, the performance data may include one or more performance metrics. For example, each of the performance metrics may include a time series (e.g., a set of data points indexed in time order, where each data point has a performance value (e.g., indicating a measurement of a performance of a component) and a time value (indicating a time at which the performance value was obtained).

Further still, in various embodiments, the current incident may be associated with a predetermined component of the system, and the one or more performance metrics may be determined for that predetermined component. For example, the performance metrics may be continuously gathered for the predetermined component while the predetermined component is operating within the system. In various embodiments, one or more performance metrics may be determined for additional components correlated to the predetermined component. For example, an initial impacted component may be determined, and then one or more additional components correlated to the impacted component may be determined. The correlation may be predetermined, may be defined by one or more models, or may be determined dynamically utilizing a trained machine learning model (e.g., an ML model that takes the predetermined component and one or more characteristics of the system as input and outputs additional components determined to be correlated to the predetermined component). One or more performance metrics may then be determined for the additional components.

Also, in various embodiments, these performance metrics may include key performance indicator (KPI) metrics. For example, the KPI metrics may include a failure rate of one or more components and/or services, a resource utilization of one or more components and/or services, etc. In another example, the KPI metrics may include a data transmission rate, a network traffic density, a processor utilization, etc. In various embodiments, the performance metrics may be determined for a plurality of layers for the component within the system. For example, the performance metrics may be determined for an infrastructure of the system, one or more cloud computing services within the system, one or more individual services within the system, etc.

In addition, in various embodiments, the performance metrics may be stored in a repository (such as a runbook) after their creation, and may be retrieved from the repository. Each of the performance metrics may have an associated time component (such as a time stamp, etc.). All performance metrics having a time component occurring within the pre-incident time window may be retrieved to form the first set of performance data.

Furthermore, at 308, anomalies are determined and labeled within the performance data to create labeled performance data. In various embodiments, each instance of performance data may include a performance metric (e.g., a KPI metric). In various embodiments, each performance metric may include a time series with a performance value and a time value (such as a timestamp).

Further still, in various embodiments, each time series may be analyzed utilizing a sliding window algorithm. For example, for each time series, a sliding window may be determined, where the sliding window has a length/duration of a subset of the time indicated within the time series. For instance, if the time series is one hundred seconds long, the sliding window may be ten seconds long. The sliding window may start at the first data point of the time series (e.g., the data point with the earliest time stamp within the time series) and may include all data points having a time stamp within the length of the sliding window. The mean and standard deviation of all performance values within the sliding window may be determined.

Also, in various embodiments, a local threshold for the sliding window may be calculated based on the mean and standard deviation for the sliding window. The local threshold may include (the mean value) plus or minus (three times the standard deviation value). In various embodiments, the performance value for each data point within the sliding window may then be compared to the local threshold for the sliding window. For example, if the performance value for a data point falls above or below the local threshold, the time series may be labeled as anomalous (e.g., using a binary value of one). In another example, if the performance value for a data point does not fall above or below the local threshold, the time series may be labeled as non-anomalous (e.g., using a binary value of zero).

Additionally, in various embodiments, after analyzing each data point within the sliding window, the start point of the sliding window may be incremented (e.g., by one data point, by a predetermined number of data points, etc.) to create an updated sliding window, and the above calculations may be performed for the updated sliding window. In various embodiments, the sliding window may be incremented until it reaches the end (e.g., the last data point) of the time series.

Further, in various embodiments, each performance metric (time series) may be labeled as anomalous (e.g., containing one or more anomalies) or non-anomalous (e.g., containing no anomalies) as a result of analyzing the data points within the performance metric utilizing the sliding window algorithm. In various embodiments, a feature matrix may be created utilizing the labeled performance data. For example, the feature matrix may include a data matrix that includes each performance metric and an indication as to whether that performance metric contains one or more anomalies.

Further still, at 310, health data for the system during the time of the current incident is determined. In various embodiments, the current incident may be associated with a predetermined component of the system, and the health data may include statistical data measured for the component (and/or additional components determined to be related to the component). For example, the health data may include one or more of average component usage, component utilization, daily/weekly service tickets issued within the component, total alarms triggered within the component, etc. In another example, the health data may be continuously measured for the component (e.g., by a third-party system, etc.).

Also, in various embodiments, the health data may be retrieved for a predetermined time period (e.g., a predetermined time period before and after the occurrence of the current incident within the system). For example, the health data may include a total number of service tickets issued for the component within the last twenty-four hours preceding the current incident, as well as a total number of service tickets issued for the component within the last seven days preceding the current incident. In various embodiments, the health data may be determined for a plurality of layers for the component within the system. For example, the health data may be determined for an infrastructure of the system, one or more cloud computing services within the system, one or more individual services within the system, etc.

In addition, at 312, a trained machine learning model determines a label for the unlabeled ticket, utilizing the unlabeled ticket, the labeled performance data, and the health data. In various embodiments, label determination may be performed when the unlabeled ticket is delivered to a user tasked with analyzing and/or resolving the incident. In various embodiments, label determination may be performed when the unlabeled ticket is removed from a queue for delivery to a destination. The machine learning model may be trained as shown in FIG. 4.

Furthermore, in various embodiments, the trained machine learning model may take the unlabeled ticket, the labeled performance data, and the health data as input. A region identifier may also be determined for the ticket, and the region identifier may also be provided as input into the trained ML environment. The trained machine learning model may perform inference on the input and may output a label for the unlabeled ticket, based on the input.

Further still, in various embodiments, the label may include a binary value. For example, a value of one may indicate that the ticket represents an incident that needs user attention, and a value of zero may indicate that the ticket represents an incident that does not need user attention. In various embodiments, the label may include an integer value indicating a severity of the incident for which the ticket was generated. For example, an incident with a severity level indicated by a first integer may be more severe than an incident with a severity level indicated by a second integer with a value less than the first integer, and incident with a severity level indicated by a first integer may be more severe than an incident with a severity level indicated by a second integer with a value greater than the first integer.

Also, in various embodiments, in response to identifying a predetermined label for the ticket (such as a value of zero indicating that the ticket represents an incident that does not need user attention), the ticket may be automatically discarded. In response to identifying a predetermined label for the ticket (such as a value of one indicating that the ticket represents an incident that needs user attention), the ticket may be automatically forwarded to a user (such as an engineer tasked with analyzing and/or resolving the incident).

Additionally, in various embodiments, labels may be determined for multiple tickets, and the tickets may be arranged according to the labels. If incidents with a label having a first integer value are determined to be more severe than incidents with a label having a second integer with a value less than the first integer, the incidents may be arranged according to the integer value of the label, where incidents with a label having a greater integer value are resolved before incidents with a label having a lesser integer value. If incidents with a label having a first integer value are determined to be more severe than incidents with a label having a second integer with a value greater than the first integer, the incidents may be arranged according to the integer value of the label, where incidents with a label having a smaller integer value are resolved before incidents with a label having a greater integer value.

FIG. 4 illustrates an example method 400 for training a machine learning model to perform automated ticket classification, according to at least one embodiment. The method 400 may be performed by one or more components of FIGS. 1-2 and 5-9. A computer-readable storage medium comprising computer-readable instructions that, upon execution by one or more processors of a computing device, cause the computing device to perform the method 400. The method 400 may performed in any suitable order. It should be appreciated that the method 400 may include a greater number or a lesser number of steps than that depicted in FIG. 4.

The method 400 may begin at 402, where an historical ticket is identified, where the historical ticket is generated in response to an occurrence of an historical incident within a system. In various embodiments, the system may include a cloud computing environment, a multi-tenant environment, etc. In various embodiments the incident may include one or more errors within the system (e.g., a dropped session within the system, a lost connection within the system, lost data within the system, component failure within the system, etc.). In various embodiments, the incident may include an alarm triggered by the system in response to one or more criteria (e.g., a dropped connection within the system, lost data within the system, etc.).

Additionally, in various embodiments, the ticket may include metadata including one or more of a description of the incident, timestamp data indicating a date and time of the incident, location data indication a location of the incident within the system, one or more components and/or users of the system affected by the incident, etc. In various embodiments, the ticket may be automatically generated by the system, manually generated by one or more users of the system, etc.

Further, in various embodiments, the incident may be associated with a predetermined component of the system. For example, the incident may occur within a predetermined entity within the system, a predetermined service provided by the system, hardware implemented within the system, etc. In another example, the incident may occur within a compute component of the system, within a storage component of the system, within a network component provided by the system, etc. The ticket may include a request (e.g., a request to one or more users) to review the incident within the system.

Further still, at 404, a label assigned to the historical ticket is identified. In various embodiments, the label may be manually assigned to the ticket by a user. In various embodiments, the user may manually review the details of the ticket and may assign the label to the ticket. In various embodiments, the label may indicate whether the additional action is needed to resolve the incident associated with the ticket. In various embodiments, the label may include a binary value. For example, a value of zero may indicate that no additional action is needed (e.g., the ticket may be ignored), and a value of one may indicate that one or more actions need to be taken to resolve the incident.

Also, in various embodiments, the label may include an integer value corresponding with a severity of the incident associated with the ticket. A first integer value may indicate a first severity level, a second integer value greater than the first integer value may indicate a second severity level greater than the first severity level, a third integer value greater than the second integer value may indicate a third severity level greater than the second severity level, etc.

In addition, at 406, a time window is determined, the time window starting at a predetermined time before the occurrence of the historical incident and ending at a time after the occurrence of the historical incident. In various embodiments, the time window may include both a pre-incident portion and post-incident portion. In various embodiments, the pre-incident portion of the time window may encompass a predetermined time duration (e.g., ten minutes, one hour, one day, etc.).

Furthermore, in various embodiments, a synchronizer system may identify a first time (T1) at which the historical incident occurred within the system (or, alternately, a time at which the historical ticket was generated). The synchronizer system may identify the time T1 by parsing one or more event logs, parsing timestamp data stored as metadata within the ticket, etc. The synchronizer system may determine the predetermined time duration D, and The pre-incident portion of the time window may be determined (e.g., by the synchronizer system) to start at time (T1-D) and to end at time T1.

Further still, in various embodiments, the post-incident portion of the time window may encompass the entire time period occurring between the occurrence of the historical incident within the system and a delivery of the historical ticket to the destination. For example, a synchronizer system may identify a first time (T1) at which the historical incident occurred within the system. The synchronizer system may identify the time T1 by parsing one or more event logs, parsing timestamp data stored as metadata within the historical ticket, etc. The synchronizer may identify a second time (T2) at which the historical ticket was delivered to the destination. The destination may include a user, the user including an engineer tasked with analyzing and/or resolving the incident. A timestamp may be recorded when the historical ticket is delivered to the destination, and this timestamp may be retrieved by the synchronizer system.

Also, in various embodiments, the post-incident portion of the time window may encompass the entire time period occurring between the occurrence of the historical incident within the system and a removal of the historical ticket from an analysis queue. For example, a synchronizer system may identify a first time (T1) at which the historical incident occurred within the system. The synchronizer system may identify the time T1 by parsing one or more event logs, parsing timestamp data stored as metadata within the historical ticket, etc. The synchronizer may identify a second time (T2) at which the historical ticket was removed from a queue (such as an analysis queue). In response to the occurrence of the historical incident within the system, the historical ticket may be generated for the event. This historical ticket may be added to a queue (such as an analysis queue). The historical ticket may be removed from the queue and delivered to a destination. A timestamp may be recorded when the historical ticket is removed from the queue, and this timestamp may be retrieved by the synchronizer system.

Additionally, in various embodiments, the post-incident portion of the time window may be determined (e.g., by the synchronizer system) to start at time T1 and to end at time T2. A length of the post-incident portion of the time window may include a default/predetermined time value. In various embodiments, a length of the post-incident portion of the time window may be calculated based on an historical status of the analysis queue. For example, the length of the post-incident portion of the time window may be determined based on an average backlog ticket time for historical tickets at the time the historical ticket was generated. The average backlog ticket time may include an average time taken to address each of the tickets in the analysis queue at the time the historical ticket is generated.

Further, at 408, performance data determined for the system during the time window is retrieved. In various embodiments, the performance data may include one or more performance metrics. Each of the performance metrics may include a time series (e.g., a set of data points indexed in time order, where each data point has a performance value (e.g., indicating a measurement of a performance of a component) and a time value (indicating a time at which the performance value was obtained). In various embodiments, the historical incident may be associated with a predetermined component of the system, and the one or more performance metrics may be determined for that predetermined component. For example, the performance metrics may be continuously gathered for the predetermined component while the predetermined component is operating within the system.

Further still, in various embodiments, one or more performance metrics may be determined for additional components correlated to the predetermined component. For example, an initial impacted component may be determined, and then one or more additional components correlated to the impacted component may be determined. The, correlation may be predetermined, defined by one or more models, or determined dynamically utilizing a trained machine learning model (e.g., an ML model that takes the predetermined component and one or more characteristics of the system as input and outputs additional components determined to be correlated to the predetermined component). One or more performance metrics may then be determined for the additional components.

Also, in various embodiments, these performance metrics may include key performance indicator (KPI) metrics. For example, the KPI metrics may include a failure rate of one or more components and/or services, a resource utilization of one or more components and/or services, etc. In another example, the KPI metrics may include a data transmission rate, a network traffic density, a processor utilization, etc. In various embodiments, the performance metrics may be determined for a plurality of layers for the component within the system. For example, the performance metrics may be determined for an infrastructure of the system, one or more cloud computing services within the system, one or more individual services within the system, etc.

In addition, in various embodiments, the performance metrics may be stored in a repository (such as a runbook) after their creation, and may be retrieved from the repository. In various embodiments, each of the performance metrics may have an associated time component (such as a time stamp, etc.). In various embodiments, all performance metrics having a time component occurring within the pre-incident time window may be retrieved to form the first set of performance data.

Furthermore, at 410, anomalies are determined and labeled within the performance data to create labeled performance data. In various embodiments, each instance of performance data may include a performance metric (e.g., a KPI metric). In various embodiments, each performance metric may include a time series with a performance value and a time value (such as a timestamp). Each time series may be analyzed utilizing a sliding window algorithm. For example, for each time series, a sliding window may be determined, where the sliding window has a length/duration of a subset of the time indicated within the time series. If the time series is one hundred seconds long, the sliding window may be ten seconds long.

Further still, in various embodiments, the sliding window may start at the first data point of the time series (e.g., the data point with the earliest time stamp within the time series) and may include all data points having a time stamp within the length of the sliding window. The mean and standard deviation of all performance values within the sliding window may be determined. A local threshold for the sliding window may be calculated based on the mean and standard deviation for the sliding window. The local threshold may include (the mean value) plus or minus (three times the standard deviation value).

Also, in various embodiments, the performance value for each data point within the sliding window may then be compared to the local threshold for the sliding window. For example, if the performance value for a data point falls above or below the local threshold, the time series may be labeled as anomalous (e.g., using a binary value of one), and if the performance value for a data point does not fall above or below the local threshold, the time series may be labeled as non-anomalous (e.g., using a binary value of zero).

Additionally, in various embodiments, after analyzing each data point within the sliding window, the start point of the sliding window may be incremented (e.g., by one data point, by a predetermined number of data points, etc.) to create an updated sliding window, and the above calculations may be performed for the updated sliding window. The sliding window may be incremented until it reaches the end (e.g., the last data point) of the time series.

Further, in various embodiments, each performance metric (time series) may be labeled as anomalous (e.g., containing one or more anomalies) or non-anomalous (e.g., containing no anomalies) as a result of analyzing the data points within the performance metric utilizing the sliding window algorithm. In various embodiments, a feature matrix may be created utilizing the labeled performance data. For example, the feature matrix may include a data matrix that includes each performance metric and an indication as to whether that performance metric contains one or more anomalies.

Further still, at 412, health data is determined for the system during the time of the historical incident. In various embodiments, the historical incident may be associated with a predetermined component of the system, and the health data may include statistical data measured for the component (and/or additional components determined to be related to the component). For example, the health data may include one or more of average component usage, component utilization, daily/weekly service tickets issued within the component, total alarms triggered within the component, etc. In another example, the health data may be continuously measured for the component (e.g., by a third-party system, etc.).

Also, in various embodiments, the health data may be retrieved for a predetermined time period (e.g., a predetermined time period before and after the occurrence of the historical incident within the system). For example, the health data may include a total number of service tickets issued for the component within the last twenty-four hours preceding the historical incident, as well as a total number of service tickets issued for the component within the last seven days preceding the historical incident. In various embodiments, the health data may be determined for a plurality of layers for the component within the system. For example, the health data may be determined for an infrastructure of the system, one or more cloud computing services within the system, one or more individual services within the system, etc.

In addition, at 414, a machine learning model is trained to determine the historical label assigned to the historical ticket, utilizing training data including the historical ticket, the historical label assigned to the historical ticket, the health data for the system during the time of the historical incident, and the labeled performance data. In various embodiments, the machine learning model may include an artificial neural network (ANN) or any other model that performs machine learning. In various embodiments, the machine learning model may be trained to determine the historical label for the ticket, utilizing the health data for the system during the time of the incident and the labeled performance data.

Furthermore, in various embodiments, during training, the machine learning model may be provided with the historical ticket, the health data for the system during the time of the historical incident, the labeled performance data, and a determined label for the historical ticket. For example, the determined label may be manually determined by a user. In various embodiments, the machine learning model may be trained to output the determined label for the historical ticket when provided with the health data for the system during the time of the historical incident and the labeled performance data.

Further still, in various embodiments, the machine learning model may output a label for the historical ticket, and the output label may be compared to the label assigned to the historical ticket. If a difference is determined between the output label and the assigned label, one or more weights may be adjusted within the machine learning model during the training, such that the difference is eliminated. In various embodiments, a region identifier may also be determined for the historical ticket, and the region identifier may also be provided as input into the ML environment during the training of the ML environment. For example, the region identifier may indicate a region within the system where the historical incident occurred. The region within the system where the historical incident occurred may be identified by examining metadata associated with the ticket, identifying one or more components of the system that were affected by the incident, etc.

Also, in various embodiments, additional historical tickets that are associated with the current historical ticket, as well as labels determined for those additional historical tickets, may also be determined and provided as input into the ML environment during the training of the ML environment. The additional historical tickets may have one or more characteristics that match the current historical ticket. The characteristics may include ticket metadata such as a description of the historical incident, timestamp data indicating a date and time of the historical incident, location data indication a location of the historical incident within the system, one or more components and/or users of the system affected by the historical incident, etc.

Additionally, in various embodiments, the label may include a binary value. For example, a value of one may indicate that the ticket represents an incident that requires user attention, and a value of zero may indicate that the ticket represents an incident that does not require user attention. In various embodiments, the label may include an integer value indicating a severity of the incident for which the ticket was generated. For example, an incident with a severity level indicated by a first integer may be more severe than an incident with a severity level indicated by a second integer with a value less than the first integer.

Further, at decision 416, it is determined whether a desired model performance is met. For example, the machine learning model may be validated after training. In another example, the machine learning model may output a confidence measurement associated with labels output by the machine learning model.

Further still, if it is determined in decision 416 that the desired model performance is met, then at 418 the trained machine learning model is deployed. If it is determined in decision 416 that the desired model performance is not met, then the method returns to step 414 where the machine learning model is trained further. For example, one or more weights may be adjusted within the machine learning model to increase the confidence measurement until the confidence measurement exceeds a predetermined threshold.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments.

Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

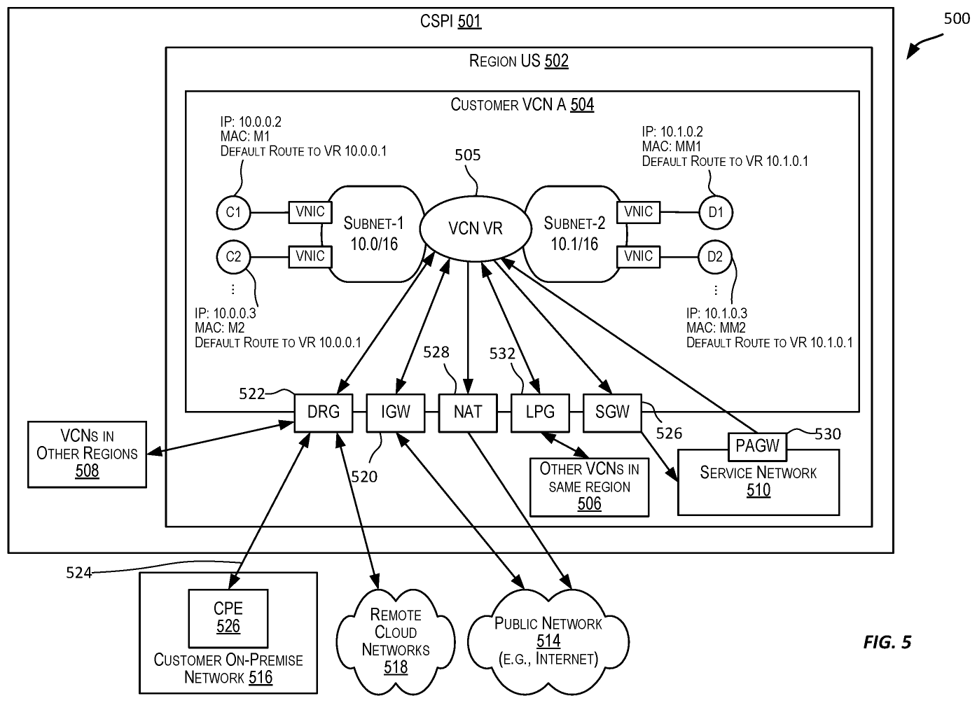

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

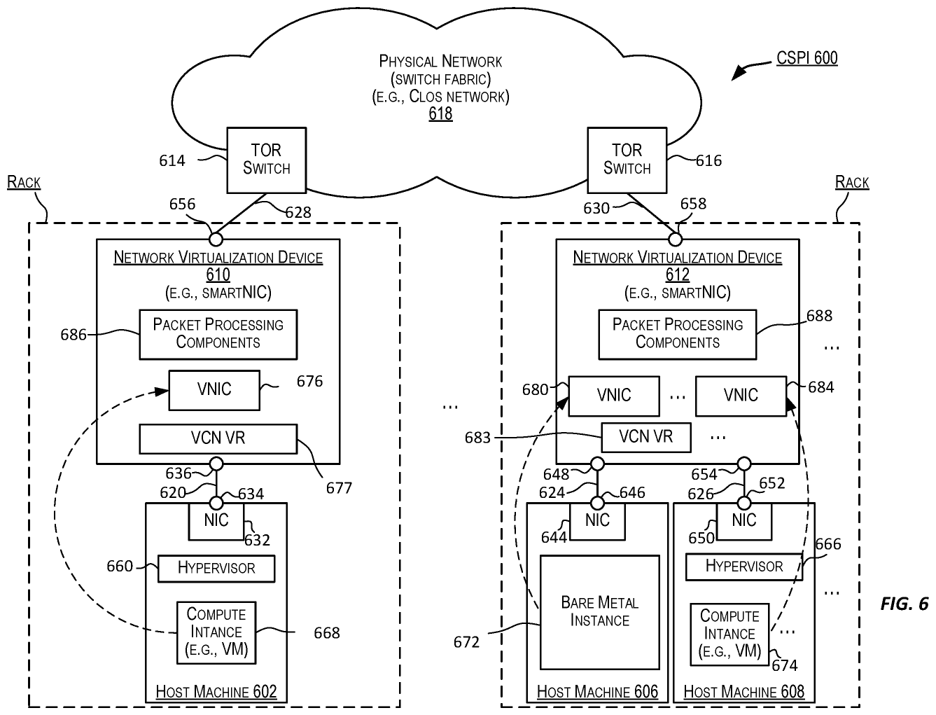

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

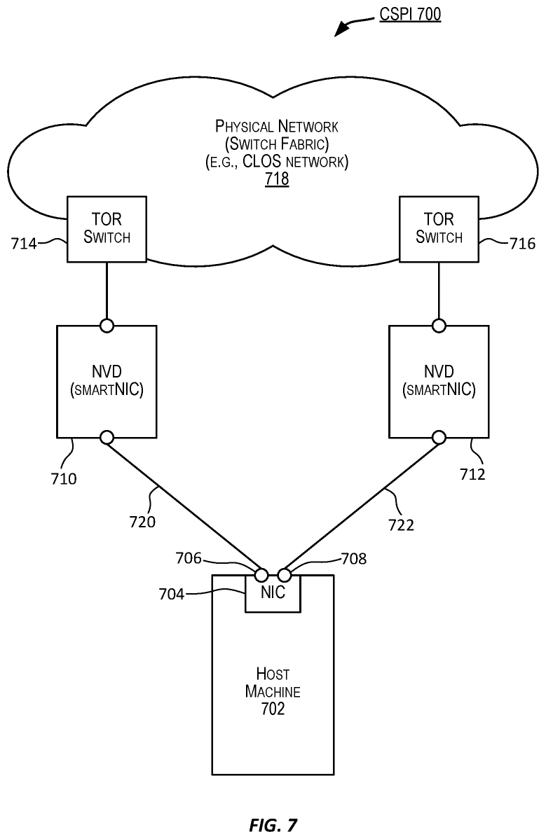

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764 (1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

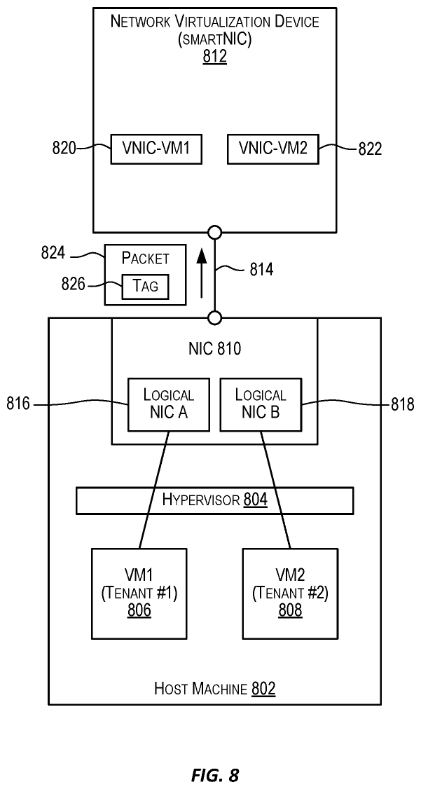

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

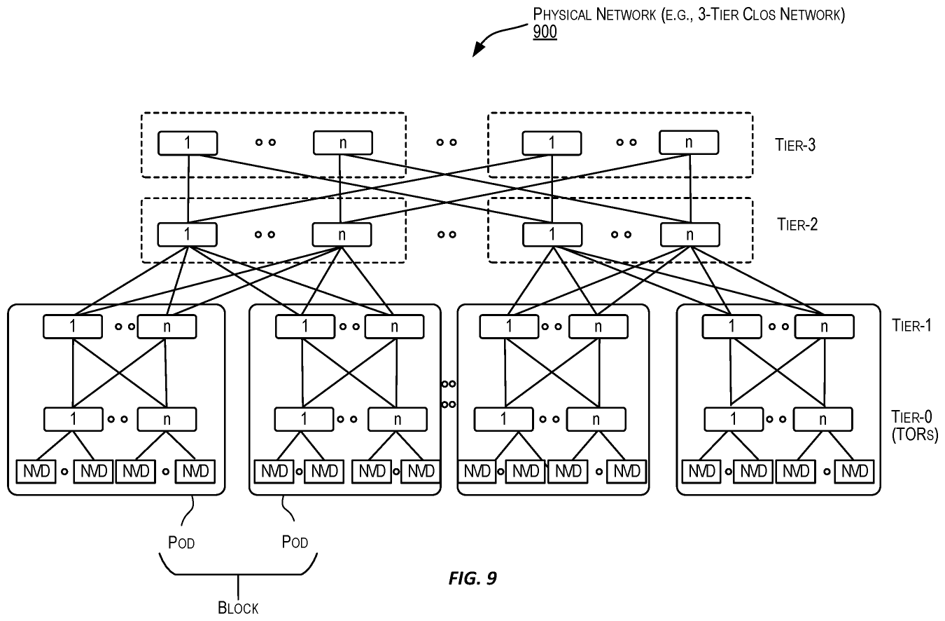

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
identifying, by a computer system, an unlabeled ticket generated in response to an occurrence of a current incident;
determining, by the computer system, a time window starting at a predetermined time before the occurrence of the current incident and ending at a time after the occurrence of the current incident;
retrieving, by the computer system, system performance data determined during the time window;
determining and labeling, by the computer system, anomalies within the system performance data to create labeled system performance data;
determining, by the computer system, system health data during the time of the current incident; and
determining, by the computer system utilizing a trained machine learning model, a label for the unlabeled ticket, utilizing the unlabeled ticket, the labeled system performance data, and the system health data.

2. The computer-implemented method of claim 1, wherein a post-incident portion of the time window includes an entire time period occurring between the occurrence of the current incident and a delivery of the unlabeled ticket to a destination

3. The computer-implemented method of claim 1, wherein a post-incident portion of the time window includes an entire time period occurring between the occurrence of the current incident and a removal of the unlabeled ticket from an analysis queue.

4. The computer-implemented method of claim 1, wherein a length of a post-incident portion of the time window is calculated based on an average time taken to address historical tickets in an analysis queue at a time the unlabeled ticket was generated.

5. The computer-implemented method of claim 1, wherein a length of a post-incident portion of the time window is calculated by averaging a post-incident portion of historical time windows for historical incidents used to train the trained machine learning model.

6. The computer-implemented method of claim 1, wherein retrieving, by the computer system, the system performance data determined during the time window includes:
identifying, by the computer system, a predetermined system component associated with the current incident;
determining, by the computer system, one or more performance metrics for the predetermined system component;
identifying, by the computer system, one or more additional system components correlated to the predetermined system component; and
determining, by the computer system, one or more performance metrics for the additional system components.

7. The computer-implemented method of claim 6, wherein a correlation between the predetermined system component and the one or more additional system components is defined by one or more models.

8. The computer-implemented method of claim 6, wherein a correlation between the predetermined system component and the one or more additional system components is determined dynamically utilizing another trained machine learning model.

9. The computer-implemented method of claim 1, further comprising creating, by the computer system, a feature matrix utilizing the labeled system performance data, wherein the feature matrix is provided as input into the trained machine learning model.

10. The computer-implemented method of claim 9, wherein the feature matrix includes a data matrix that includes a plurality of system performance metrics and an indication as to whether each system performance metric contains one or more anomalies.

11. A system comprising:
one or more processors configured to:
identify an unlabeled ticket generated in response to an occurrence of a current incident;
determine a time window starting at a predetermined time before the occurrence of the current incident and ending at a time after the occurrence of the current incident;
retrieve system performance data determined during the time window;
determine and label anomalies within the system performance data to create labeled system performance data;
determine system health data during the time of the current incident; and
determine, utilizing a trained machine learning model, a label for the unlabeled ticket, utilizing the unlabeled ticket, the labeled system performance data, and the system health data.

12. The system of claim 11, wherein a post-incident portion of the time window includes an entire time period occurring between the occurrence of the current incident and a delivery of the unlabeled ticket to a destination.

13. The system of claim 11, wherein a post-incident portion of the time window includes an entire time period occurring between the occurrence of the current incident and a removal of the unlabeled ticket from an analysis queue.

14. The system of claim 11, wherein a length of a post-incident portion of the time window is calculated based on an average time taken to address historical tickets in an analysis queue at a time the unlabeled ticket was generated.

15. The system of claim 11, wherein a length of a post-incident portion of the time window is calculated by averaging a post-incident portion of historical time windows for historical incidents used to train the trained machine learning model.

16. The system of claim 11, wherein retrieving the system performance data determined for the system during the time window includes:
identifying a predetermined system component associated with the current incident;
determining one or more performance metrics for the predetermined system component;
identifying one or more additional system components correlated to the predetermined system component; and
determining one or more performance metrics for the additional system components.

17. The system of claim 16, wherein a correlation between the predetermined system component and the one or more additional system components is defined by one or more models.

18. The system of claim 16, wherein a correlation between the predetermined system component and the one or more additional system components is determined dynamically 2 utilizing another trained machine learning model.

19. The system of claim 11, wherein the one or more processors are further configured to create a feature matrix utilizing the labeled system performance data, wherein the feature matrix is provided as input into the trained machine learning model.

20. A computer-implemented method, comprising:
identifying, by a computer system, an historical ticket generated in response to an occurrence of an historical incident within a system;
identifying, by the computer system, a label assigned to the historical ticket;
determining, by the computer system, a time window starting at a predetermined time before the occurrence of the historical incident and ending at a time after the occurrence of the historical incident;
retrieving, by the computer system, system performance data determined during the time window;
determining and labeling, by the computer system, anomalies within the system performance data to create labeled system performance data;
determining, by the computer system, health data for the system during the time of the historical incident; and
training, by the computer system, a machine learning model to determine the label assigned to the historical ticket, utilizing training data including the historical ticket, the label assigned to the historical ticket, the health data for the system during the time of the historical incident, and the labeled system performance data.
